(19) United States
(12) Patent Application Publication
(10) Pub. No.: US 2013/0132528 A1
(43) Pub. Date: May 23, 2013

(54) APPLICATION DISTRIBUTION SYSTEM, APPLICATION DISTRIBUTION METHOD, TERMINAL, AND PROGRAM

(71) Applicants: Nobuyuki Enomoto, Tokyo (JP); Kohei Haga, Tokyo (JP); Yohei Taoka, Tokyo (JP); Takanori Hiroshima, Tokyo (JP)

(72) Inventors: Nobuyuki Enomoto, Tokyo (JP); Kohei Haga, Tokyo (JP); Yohei Taoka, Tokyo (JP); Takanori Hiroshima, Tokyo (JP)

(21) Appl. No.: 13/813,524

(22) PCT Filed: Jul. 1, 2011
(86) PCT No.: PCT/JP2011/065198

§ 371 Date: Jan. 31, 2013

(30) Foreign Application Priority Data
Aug. 10, 2010 (JP) 2010-179404

(51) Int. Cl. G06F 15/16

(52) U.S. Cl. CPC G06F 15/16
USPC 709/219

(57) ABSTRACT

Certificate data contained in an execution file have been stored as a certificate file in protected data storage area 14 that has been access-restricted. Thereafter, when an execution file that does not contain certificate data is distributed as an update execution tile from application distribution server 40, the update execution file is executed based on the certificate file stored in protection data storage area 14 so as to use the application.

### TECHNICAL HELD

The present invention relates to an application distribution system, an application distribution method, a terminal, and a program that distribute an application that serves to communicate with a server, in particular, to a protection technique for a certificate that is necessary when the application is used.

### BACKGROUND ART

In recent years, a platform based on a software stack package composed of an open source operating system, middleware, and primary applications has been released for smartphones, Internet terminals, tablet terminals, and so forth (for example, refer to Non-Patent Literature 1).

The foregoing platform is provided with a mechanism in which root privilege is not granted to the user of a terminal, but a unique Linux user ID is assigned to each of packages that have been installed on the terminal, each application is executed based on the Linux user ID, and a file created by the execution of the application is stored in a protected data storage area such that other applications and the user of the terminal cannot read and write the protected data storage area (for example, refer to Non-Patent Literature 2).

The foregoing platform is also provided with a mechanism that protects an application from being copied. An application that has been designated to be in the protection state is installed in a protected application storage area from and to which an unauthorized user cannot read and write data (for example, refer to Non-Patent Literature 3).

If an application that has been designated to be in the protection state is installed, files other than an application execution file (.dex) contained in a package (.apk) are not installed to the protected area from and to which an unauthorized user cannot read and write data, but a non-protected area from and to which an unauthorized user can read and write data. Thus, if a package file that contains an application execution file together with a client certificate file is installed, the client certificate file will not be installed in the protected area. As a result, the user might remove the client certificate that the application uses from the package file (for example, refer to Non-Patent Literature 4).

A technique that can solve such a problem has been contemplated. Namely, an execution the of an application program contains a certificate so as to easily install both the execution file and the certificate (for example, refer to Patent Literature 1). Using this technique, since the certificate is installed in the protected area together with the execution file, the user can be prevented from removing the client certificate that the application uses from the package.

In the foregoing platform, it is preferred that applications that have been installed be updated. To do that, a mechanism that distributes a package that is necessary to newly install an application and to update it is provided as a server called market on Internet. When an application is updated, a package file containing an application execution file, a client certificate file, and certificate data is uploaded to the server called market so as to update the application (for example, refer to Non-Patent Literature 5).

### RELATED ART LITERATURE

### Patent Literature

Patent Literature 1: JP2007-272610A, Publication

### Non-Patent Literature

Non-Patent Literature 1: Android-Wikipedia http://ja.wikipedia.org/wiki/Android

Non-Patent Literature 2: Android Developers Security and Permissions http://developer,android.com/guide/topics/security/security.html#userid

Non-Patent Literature 3: Forward-Locked Applications http://developer.android.com/guide/appendix/market-filters.html#other-filters

Non-Patent Literature 4: App Install Location http://developer.android.com/ guide/appendix/install-location.html

Non-Patent Literature 5: Publishing Your Applications http://developer.android.com/guide/publishing/publishing.html

### SUMMARY OF THE INVENTION

### Problem to be Solved by the Invention

However, when an application is updated in the foregoing manner, since a package file containing an application execution file, a client certificate file, and certificate data is uploaded to the server, if the administrator of the server that distributes the application is malicious, he or she might remove the client certificate file and certificate data from the package file. Since the server that distributes applications may not be installed by the manufacturer of the terminal to which applications are distributed, a malicious administrator can administer the server.

The present invention was made from a point of view of problems that reside in the foregoing techniques. An object of the present invention is to provide an application distribution system, an application distribution method, a terminal, and a program that allow an application to be updated in a state in which an administrator of a server that distributes update applications cannot access client certificates.

### Means that Solve the Problem

To accomplish the foregoing object, the present invention is an application distribution system, comprising:

a terminal that executes an installed execution file of an application and then uses the application; and

an application distribution server that distributes an update execution file of said application to said terminal,

wherein the execution file installed in the terminal is updated to said update execution file distributed from said application distribution server to said terminal,

wherein the execution file installed in said terminal contains certificate data that are necessary to use said application, and

wherein said terminal stores the certificate data contained in said execution file as a certificate file in a first storage area that has been access-restricted and when an execution file that does not contain said certificate data is distributed as said update execution file from said application distribution server, said terminal executes the update execution file based on the certificate file stored in said first storage area so as to use the application.

In addition, the present invention is an application distribution method for a application distribution system, including a terminal that executes an installed execution file of an application and then uses the application; and an application distribution server that distributes an update execution file of said application to said terminal, the execution file installed in the terminal being updated to said update execution file distributed from said application distribution server to said terminal, the execution file installed in said terminal containing certificate data that are necessary to use said application, said application distribution method comprising the processes of:

causing said terminal to store the certificate data contained in said execution file as a certificate tile in a first storage area that has been access-restricted;

causing said application distribution server to distribute an execution tile that does not contain said certificate data as said update execution tile to said terminal; and

causing said terminal to execute the update execution tile distributed from said application distribution server based on the certificate file stored in said first storage area so as to use the application.

In addition, the present invention is a terminal that executes an installed execution file of an application and then uses the application and that updates the installed execution file in an update execution file distributed from said application distribution server,

wherein the execution file installed in said terminal contains certificate data that are necessary to use said application, and

wherein certificate data contained in said execution file are stored as a certificate file in a first storage area that has been access-restricted and when an execution file that does not contain said certificate data is distributed as said update execution file from said application distribution server, the update execution file is executed based on the certificate file stored in said first storage area so as to use the application.

In addition, the present invention is a program that causes a terminal, that executes an installed execution file of an application and then uses the application and that updates the installed execution file to an update execution file distributed from said application distribution server, to execute the steps comprising:

storing certificate data that are contained in a provided execution file and that are necessary to use the application as a certificate file in a first storage area that has been access-restricted; and

executing the update execution file based on the certificate file stored in said first storage area so as to use the application when an execution file that does not contain said certificate data is distributed as said update execution file from said application distribution server.

### Effect of the Invention

According to the present invention, certificate data contained in an execution file are stored as a certificate tile in a first storage area that has been access-restricted. Thereafter, if an execution file that does not contain certificate data is distributed as an update execution tile, the update execution file is executed based on the certificate file stored in the first storage area so as to use the application. Thus, the application can be updated in a state in which the administrator of the server that distributes the update application cannot access the client certificate.

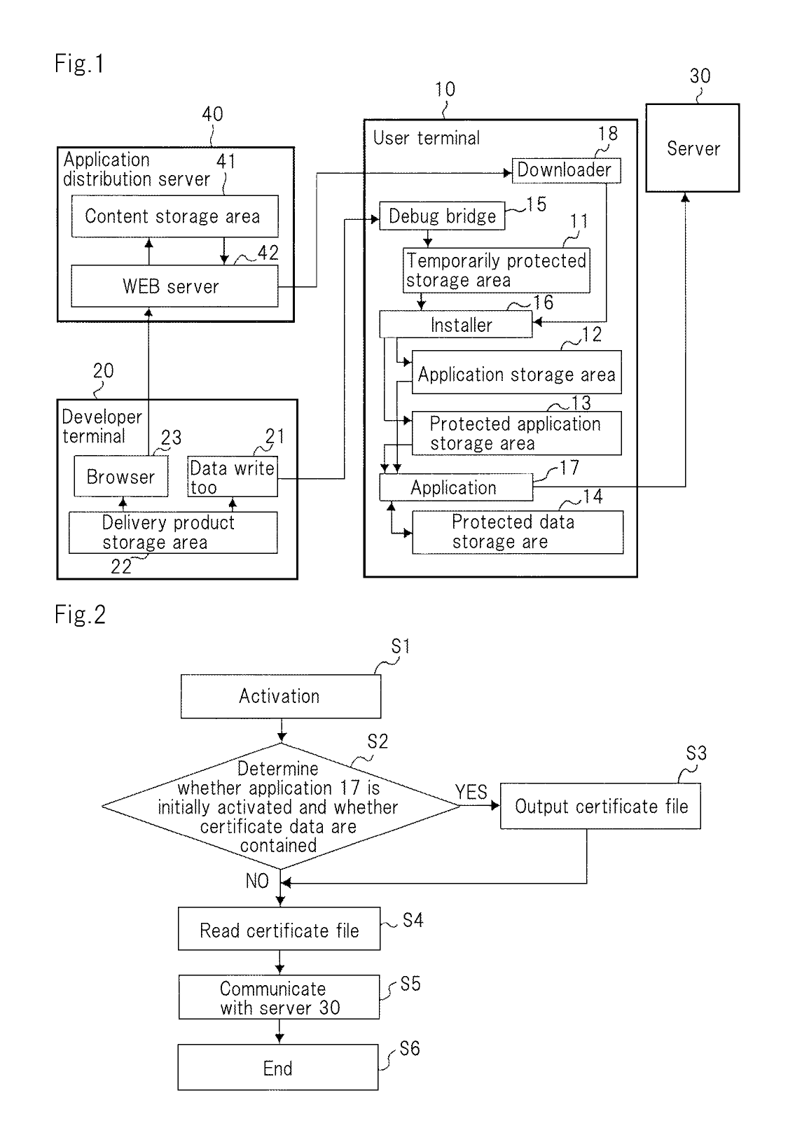

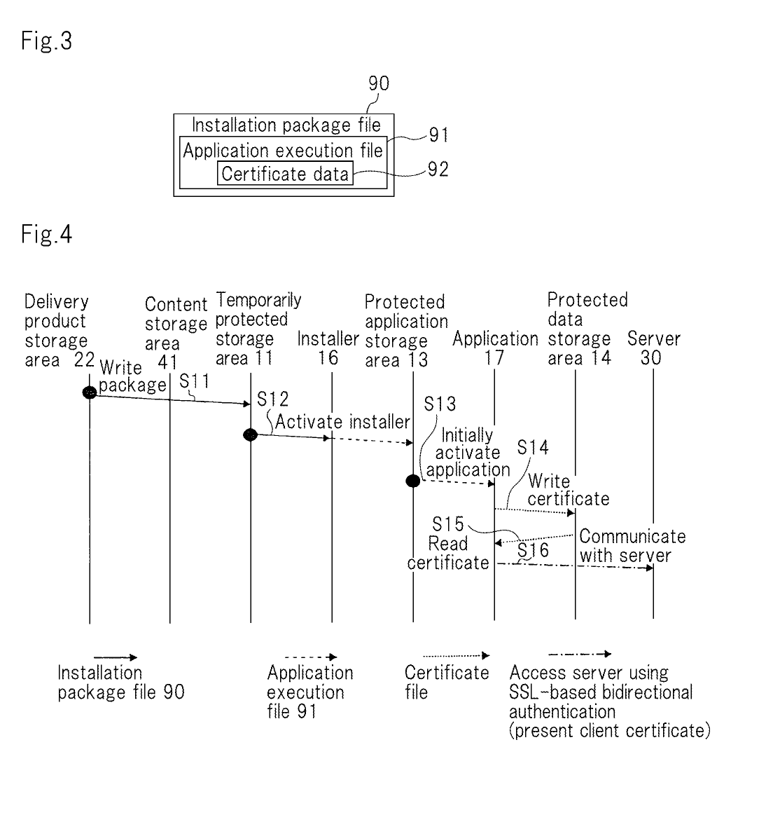

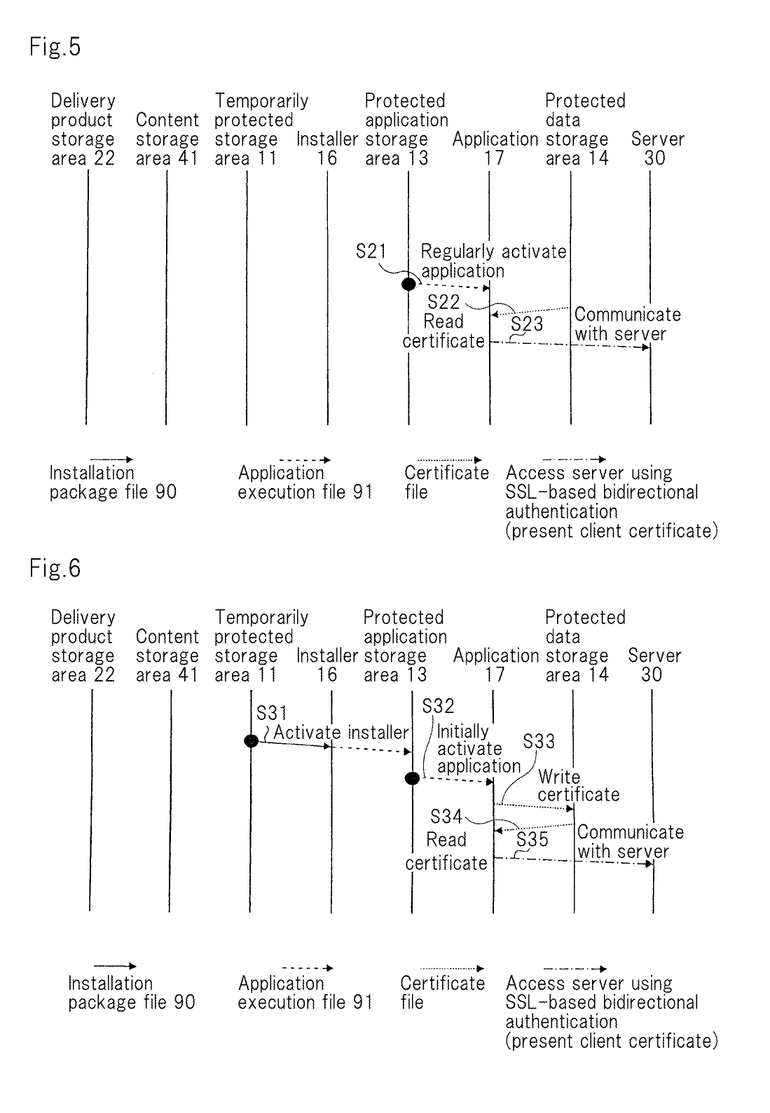

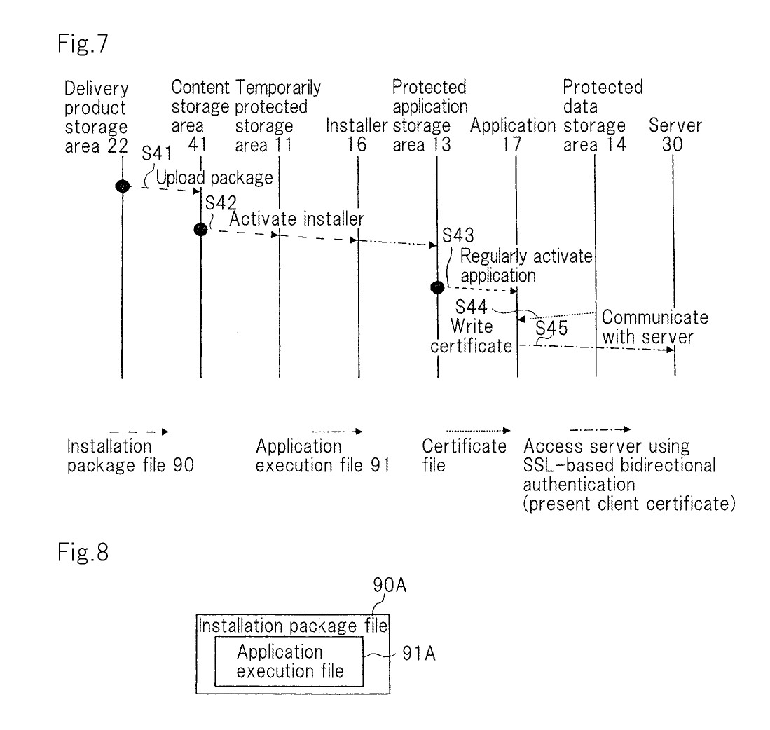

### BRIEF DESCRIPTION OF DRAWINGS

[FIG. 1] is a block diagram showing an application distribution system according to an embodiment of the present invention.

[FIG. 2] is a flow chart describing a basic operation for an application shown in FIG. 1.

[FIG. 3] is a schematic diagram showing the structure of an installation package file stored in a protected application storage area shown in FIG. 1.

[FIG. 4] is a timing chart describing a pre-installation operation for the installation package file shown in FIG. 3 in the application distribution system shown in FIG. 1.

[FIG. 5] is a timing chart describing a regular activation operation for an application in the application distribution system shown in FIG. 1.

[FIG. 6] is a timing chart describing a full reset operation that the user performs for a user terminal in the application distribution system shown in FIG. 1.

[FIG. 7] is a timing chart describing an update operation for an application in the application distribution system shown in FIG. 1.

[FIG. 8] is a schematic diagram showing the structure of an update version installation package file stored in a delivery product storage area of a developer terminal shown in FIG. 1.

### BEST MODES THAT CARRY OUT THE INVENTION

Next, with reference to the accompanying drawings, embodiments of the present invention will be described.

FIG. 1 is a block diagram showing an application distribution system according to an embodiment of the present invention.

As shown in FIG. 1, the application distribution system according to this embodiment is composed of user terminal 10, developer terminal 20, server 30, and application distribution server 40.

When user terminal 10 uses an application, user terminal 10 executes an installed execution file and accesses server 30. User terminal 10 is composed of temporarily protected storage area 11, application storage area 12, protected application storage area 13, protected data storage area 14, debug bridge 15, installer 16, application 17, and downloader 18. User terminal 10 might be, for example, a portable information terminal (PDA: Portable Data Assistant) or a portable telephone terminal each of which is provided with an OS such as Android. The root privilege of user terminal 10 is not granted to its user. Each package installed in user terminal 10 is assigned a unique Linux user ID. Each application is executed based on the Linux user ID. The root privilege is granted only to an authorized person of the manufacturer of user terminal 10.

Developer terminal 20 is a terminal such as a personal computer on which applications installed to user terminal 10 are developed. Engineers of the manufacturer of user terminal 10 use developer terminal 20. Developer terminal 20 is composed of data write tool 21, delivery product storage area 22, and browser 23.

Server 30 is a WEB server that necessitates SSL-based bidirectional authentication.

Application distribution server 40 is a server that is located on the Internet and that distributes applications to user terminal 10. Application distribution server 40 is composed of content storage area 41 and WEB server 42. Application distribution server 40 is a server that is generally called market.

First, the constituent elements of user terminal 10 will be described.

Temporarily protected storage area 11 corresponds to a second storage area of the present invention, Temporarily protected storage area 11 stores a tile received from developer terminal 20 through debug bridge 15. When installer 16 operates as commanded by debug bridge 15 or a startup script of user terminal 11, a tile stored in temporarily protected storage area 11 is passed to installer 16 that operates on memory (not shown) of user terminal 10. Only a root-privileged user who is a pre-designated user can store and read a file in and from temporarily protected storage area 11. In other words, only an authorized person of the manufacturer of user terminal 10 can store and read a file in and from temporarily protected storage area 11. Thus, a user, including the purchaser, of user terminal 10 cannot read a file from temporarily protected storage area 11. Files stored in temporarily protected storage area 11 are not erased even if user terminal 10 is fully reset (restored to the factory default state).

Application storage area 12 stores an application execution file and ancillary files received from installer 16. When application 17 is executed or when requested by application 17, files stored in memory of user terminal 10 are passed to application 17. Even a user who has not been root-privileged can store and read a file in and from application storage area 12. When user terminal 10 is fully reset, files stores in application storage area 12 are erased. Application storage area 12 corresponds to “/data/app” of Android.

Protected application storage area 13 corresponds to a third storage area of the present invention. Protected application storage area 13 stores an application execution file received from installer 16. When the application is executed, files stored in protected application storage area 13 are passed to memory of user terminal 10. Only a root-privileged user can store and read a file in and from protected application storage area 13. In other words, only an authorized person of the manufacturer of user terminal 10 can store and read a file in and from protected application storage area 13. As a result, a user, including the purchaser, of user terminal 10 cannot read a file from protected application storage area 13. When user terminal 10 is fully reset, files stored in protected application storage area 13 are erased. Protected application storage area 13 corresponds to “/data/app-private” of Android.

Protected data storage area 14 corresponds to a first storage area of the present invention.

Protected data storage area 14 stores a file received from application 17. When requested by application 17, a file stored in protected data storage area 14 is passed to application 17. Only a root-privileged user, an application that has created a file, or an application signed with the same code signing certificate as the application that has created the file access protected data storage area 14 so as to store and read a file in and from protected data storage area 14. Thus, when user terminal 10 is a terminal provided with Android OS, only an authorized person of the manufacture of user terminal 10 or application 17 can store and read a the in and from protected data storage area 14. A user, including the purchaser, of user terminal 10 cannot read a file from protected data storage area 14. When user terminal 10 is fully reset, files stored in protected data storage area 14 are erased. Protected data storage area 14 corresponds to “/data/data/application name” of Android (for example, jp.ne.biglobe.applicationname).

When commanded by data write tool 21 of developer terminal 20, debug bridge 15 executes commands that install an application, activate it, and operate a file. In addition, debug bridge 15 passes a file received from data write tool 23 to temporarily protected storage area 11 so that it stores the received file. Data write tool 21 and debug bridge 15 are connected with a USB cable or the like. Debug bridge 15 corresponds to “adb” of Android.

Installer 16 corresponds to a first processing means of the present invention. When commanded by debug bridge 15 or a startup script, installer 16 reads an installation package file from temporarily protected storage area 11, performs necessary settings for an application that is installed (for example, registers the application to the menu), and then stores the installation package file in application storage area 12 or protected application storage area 13. On the other hand, when commanded by downloader 18, installer 16 reads an installation package file from downloader 18, performs necessary settings for an application that is installed (registers the application to the menu), and stores the installation package file in application storage area 12 or protected application storage area 13. When installer 16 installs an application that has been designated to be in the protection state (generally called forward-locked), only an execution file is stored in protected application storage area 13. Files other than the execution file are stored in application storage area 12. If the application has not been designated to be in the protected state, all files are stored in application storage area 12. According to this embodiment, it is assumed that all applications have been designated to be in the protected state.

Application 17 corresponds to a second processing means of the present invention.

When commanded by debug bridge 15, by a startup script, or on the menu, application 17 is activated. When an application execution file contained in an installation package file stored in protected application storage area 13 is loaded into memory of user terminal 10, application 17 is activated. When an application is initially activated, certificate data contained in the application execution tile is decompressed as a certificate tile and stored in protected data storage area 14. Application 17 communicates with server 30. At this point, if certificate file 92 is present in protected data storage area 14, application 17 reads the tile from protected data storage area 14 and presents the tile as a client certificate to server 30 so as to denote that the terminal can access server 30.

Downloader 18 periodically communicates with WEB server 42 of application distribution server 40 and inquires whether application distribution server 40 has an update execution tile for an application that has been installed in user terminal 10. if application distribution server 40 has an update execution file for the application, downloader 18 receives an installation package file containing the update execution file from WEB server 42 of application distribution server 40 through Internet and passes the received update execution file to installer 16.

Next, the constituent elements of developer terminal 20 will be described.

Data write tool 21 logs in as a root-privileged user to user terminal 10 and transfers a file stored in delivery product storage area 22 to temporarily protected storage area 11 through debug bridge 15 when commanded by the operator of developer terminal 20. In addition, data write tool 21 transmits commands that install an application, activates it, and operate a file to user terminal 10 through debug bridge 15. Data write tool 21 and debug bridge 15 are connected with a USB cable or the like.

Delivery product storage area 22 is an area that stores files that are passed to temporarily protected storage area 11 of user terminal 10 through data write tool 21.

Browser 23 accesses WEB server 42 of application distribution server 40 and uploads a file stored in delivery product storage area 22 to application distribution server 40. Browser 23 and WEB server 42 are connected through the Internet.

Next, server 30 will be described in detail.

When server 30 receives a connection request from application 17, server 30 presents its own application certificate to application 17 and requests that application 17 present its own client certificate to server 30. Only when application 17 presents a correct client certificate to server 30, is the connection request from accepted. Server 30 and application 17 of user terminal 10 are connected through the Internet.

Next, the constituent elements of application distribution server 40 will be described.

Content storage area 41 stores a file received from WEB server 42. In addition, when requested by WEB server 42, content storage area 41 passes a file to WEB server 42.

WEB server 42 accepts a file uploaded from browser 23 through the Internet and stores the file in content storage area 41. In addition, when requested by downloader 18, WEB server 42 reads a file from content storage area 41 and transfers it to downloader 18 through the Internet.

Next, an application distribution method for the foregoing application distribution system will be described.

First, a basic operation for application 17 shown in FIG. 1 will be described.

FIG. 2 is a flow chart describing the basic operation for application 17 shown in FIG. 1.

When commanded by debug bridge 15, by a startup script, or on the menu, application 17 is activated. When an application execution file contained in an installation package file stored in protected application storage area 13 is loaded into memory of user terminal 10, application 17 is activated (at step 1).

FIG. 3 is a schematic diagram showing the structure of an installation package file stored in protected application storage area 13 shown in FIG. 1.

Installer 16 stores installation package file 90 that has been read from temporarily protected storage area 11 to protected application storage area 13 shown in FIG. 1. Installation package file 90 is an installation package that is used when an application is pre-installed in user terminal 10. Thus, as shown in FIG. 3, installation package file 90 contains application execution file 91. When application execution file 91 is installed, installer 16 stores installation package file 90 in protected application storage area 13. Installation package file 90 is an archive of tiles and so forth that are necessary to install an application. In the Android system, installation package tile 90 generally has extension “apk.” Application execution tile 91 is an execution tile of application 17 that operates on user terminal 10. Application execution tile 91 contains certificate data 92 used as a client certificate. In the Android system, application execution tile 91 generally has extension “dex”. Certificate data 92 are client certificate data stored in application execution file 91.

When application 17 is initially activated and application execution file 91 contains certificate data 92 (namely, after application execution file 91 is loaded, when application 17 is executed) (at step 2), application 17 decompresses certificate data 92 contained in installation package file 90 stored in protected application storage area 13 as a certificate file and stores certificate data 92 in protected data storage area 14 (at step 3). A certificate file is a file composed of client certificate data that are necessary when application 17 communicates with server 30. A certificate file is contained in application execution file 91 as certificate data 92 when application execution file 91 is created on developer terminal 20.

Thereafter, application 17 reads the certificate file from protected data storage area 14 (at step 4).

Thereafter, application 17 uses the certificate file read from protected data storage area 14 as a client certificate so as to perform SSL-based bidirectional authentication and communication with server 30 (at step 5).

After application 17 has completed communication with server 30, the basic operation for application 17 is complete (at step 6).

Next, a pre-install operation for installation package file 90 shown in FIG. 3 in the application distribution system shown in FIG. 1 will be described.

FIG. 4 is a timing chart describing the pre-install operation for the installation package file shown in FIG. 3 in the application distribution system shown in FIG. 1.

It is assumed that user terminal 10 is located, for example, at a factory of the manufacturer thereof and that debug bridge 15 of user terminal 10 and data write tool 21 of developer terminal 20 are connected with a USB cable. In addition, it is assumed that developer terminal 20 logs in as a root-privileged user to user terminal 10.

An engineer of the manufacturer of user terminal 10 places installation package tile 90 in delivery product storage area 22 of developer terminal 20. As shown in FIG. 3, installation package tile 90 contains application execution tile 91, whereas application execution tile 91 contains certificate data 92.

Thereafter, the engineer writes installation package file 90 stored in delivery product storage area 22 to temporarily protected storage area 11 through debug bridge 15 using data write tool 21. At this point, installation package file 90 is set up such that when the user initially activates user terminal 10, installer 16 is activated to install installation package file 90 that has been designated to be in the protected state (at step 11).

After the foregoing operation has been completed, user terminal 10 is delivered from the factory to the user.

The user receives user terminal 10 from the factory and activates user terminal 10.

Since installation package file 90 has been set up such that when user terminal 10 is initially activated, installer 16 is activated to install installation package file 90 that has been designated to be in the protected state to user terminal 10, installer 16 is activated to read installation package file 90 from temporarily protected storage area 11, perform necessary settings for an application that is installed (for example, registers it to the menu), extract application execution file 91 from installation package file 90, and write application execution file 91 to protected application storage area 13 (at step 12). Application execution file 91 contains certificate data 92.

As a result, installation package file 90 has been installed in user terminal 10.

When the user commands application 17 to be activated on the menu of user terminal 10, application execution file 91 stored in protected application storage area 13 is loaded into the memory of user terminal 10 together with certificate data 92 and then activated as application 17 (at step 13).

Since application 17 is initially activated and application execution file 91 contains certificate data 92, they are decompressed as a certificate file and stored in protected data storage area 14 (at step 14).

Thereafter, application 17 reads the certificate tile from protected data storage area 14 (at step 15). Then, application 17 executes application execution file 91 stored in protected application storage area 13 and presents data of the certificate file as a client certificate read from protected data storage area 14 to server 30 so as to perform SSL-based bidirectional authentication and communication with server 30 (at step 16).

After application 17 has completed communication with server 30, the operation for application 17 is complete.

As a result, the certificate file has been written to protected data storage area 14 and communication with server 30 is complete.

Next, a regular activation operation (not initial activation operation) of application 17 in the application distribution system shown in FIG. 1 will be described.

FIG. 5 is a timing chart describing the regular activation operation for application 17 in the application distribution system shown in FIG. 1.

When the user commands application 17 to be activated on the menu of user terminal 10, application execution file 91 stored in protected application storage area 13 is loaded into memory together with certificate data 92 and then activated as application 17 (at step 21).

Since application 17 is not initially activated, it reads the certificate file from protected data storage area 14 (at step 22). Thereafter, application 17 executes application execution file 91 stored in protected application storage area 13 and presents data of the certificate file as a client certificate read from protected data storage area 14 to server 30 so as to perform SSL-based bidirectional authentication and communication with server 30 (at step 23).

After application 17 has completed communication with server 30, the operation for application 17 is complete.

As a result, application 17 has normally communicated with server 30.

Next, a full reset operation that the user performs for user terminal 10 in the application distribution system shown in FIG. 1 will be described.

FIG. 6 is a timing chart describing the full reset operation that the user performs for user terminal 10 in the application distribution system shown in FIG. 1.

It is assumed that the user has initially activated both user terminal 10 and application 17. In other words, it is assumed that steps 11 to 16 of FIG. 4 have been complete.

When the user performs the full reset operation for user terminal 10, all files stored in application storage area 12, protected application storage area 13, and protected data storage area 14 are erased. Although application execution file 91 stored in protected application storage area 13 and the certificate file stored in protected data storage area 14 are erased, installation package file 90 stored in temporarily protected storage area 11 is not erased.

After the user has performed the full reset operation, when he or she initially activates user terminal 10, since user terminal 10 has been set up such that installation package file 90 that has been designated to be in the protection state is installed, installer 16 is activated to read installation package file 90 from temporarily protected storage area 11, perform necessary settings for an application that is installed (for example, registers it to the menu), extract application execution file 91 from installation package file 90, and store it to protected application storage area 13 (at step 31). Application execution file 91 contains certificate data 92.

As a result, installation package file 90 has been installed in user terminal 10.

Thereafter, when the user commands application 17 to be activated on the menu of user terminal 10, application execution file 91 stored in protected application storage area 13 is loaded into memory together with certificate data 92 and then activated as application 17 (at step 32).

Since application 17 is initially activated and application execution file 91 contains certificate data 92, application 17 decompresses certificate data 92 as a certificate file and stores the certificate file in protected data storage area 14 (at step 33).

Thereafter, application 17 reads the certificate file from protected data storage area 14 (at step 34). Then, application 17 executes application execution file 91 stored in protected application storage area 13 and presents data of the certificate file as a client certificate read from protected data storage area 14 to server 30 so as to perform SSL-based bidirectional authentication and communication with server 30 (at step 35).

After application 17 has completed communication with server 30, the operation for application 17 is complete.

As a result, certificate data 92 have been decompressed as a certificate file and stored in protected data storage area 14, and then communication with server 30 is complete.

Next, an update operation for application 17 in the application distribution system shown in FIG. 1 will be described.

FIG. 7 is a timing chart describing the update operation for application 17 in the application distribution system shown in FIG. 1.

It is assumed that the user has obtained user terminal 10, that he or she has initially activated user terminal 10, and that he or she has initially activated application 17. In other words, it is assumed that steps 11 to 16 have been complete. In addition, it is assumed that debug bridge 15 of user terminal 10 and data write tool 21 of developer terminal 20 are not connected with a USB cable and instead that browser 23 of developer terminal 20 and WEB server 42 of application distribution server 40 or WEB server 42 of application distribution server 40 and downloader 18 of user terminal 10 are connected through the Internet.

An engineer of the manufacturer of user terminal 10 places an update version of installation package file 90 in delivery product storage area 22 of developer terminal 20. At this point, the engineer sets up the update version of installation package file 90 such that it is designated to be in the protection state and installed.

FIG. 8 is a schematic diagram showing the structure of the update version of the installation package file placed in delivery product storage area 22 of developer terminal 20 shown in FIG. 1.

Update version installation package file 90A placed in delivery product storage area 22 of developer terminal 20 is an installation package that is used when an application that has been installed in user terminal 10 is updated. Thus, as shown in FIG. 8, installation package file 90A contains update application execution file 91A. Installation package file 90A is an archive of files and so forth that are necessary to install an application. In the Android system, installation package file 90A generally has extension “apk.” Application execution file 91A is an execution file of application 17 that operates on user terminal 10. Unlike application execution file 91 shown in FIG. 3, application execution file 91A does not contain certificate data 92 used as a client certificate.

The engineer writes installation package file 90A stored in delivery product storage area 22 to content storage area 41 through browser 23 (at step 41).

Downloader 18 periodically communicates with WEB server 42 of application distribution server 40 and inquires of WEB server 42 whether or not it contains an update version of application 17 that has been installed in user terminal 10. At this point, downloader 18 knows that installation package file 90A that is an update version installation package file of application 17 is present in content storage area 41, receives update version installation package file 90A from WEB server 42 through the Internet, and passes the file that has been designated to be in the protected state to installer 16.

When installer 16 receives installation package file 90A from downloader 18, installer 16 performs necessary settings for an application that is installed (for example, registers it to the menu), extracts application execution file 91A from installation package file 90A, and stores it in protected application storage area 13. At this point, installer 16 erases application execution file 91 from protected application storage area 13 so as to replace application execution file 91 stored in protected application storage area 13 with application execution file 91A (at step 42).

As a result, application execution file 91 stored in protected application storage area 13 has been updated to application execution file 91A.

Next, a regular activation operation for application 17 that has been updated in the foregoing manner will be described.

When the user commands application 17 to be activated on the menu of user terminal 10, application execution file 91A stored in protected application storage area 13 is loaded to memory and then activated as application 17 (at step 43).

Since application execution file 91A does not contain certificate data, application 17 reads the certificate file from protected data storage area 14 (at step 44). Thereafter, application 17 executes application execution file 91 stored in protected application storage area 13 and presents data of the certificate file as a client certificate read from protected data storage area 14 to server 30 so as to perform SSL-based bidirectional authentication and communication with server 30 (at step 45).

After application 17 has completed communication with server 30, the operation for application 17 is complete.

As a result, updated application 17 has normally communicated with server 30.

Next, effects of this embodiment will be described.

In this embodiment, since application execution file 91 of installation package file 90 that developer terminal 20 provides to user terminal 10 contains certificate data 92, an application and a client certificate can be installed to user terminal 10 and the application can be updated in a state in which the user cannot access the client certificate that the application uses.

In addition, user terminal 10 is delivered in a state in which application execution file 91 that contains certificate data 92 has been stored in temporarily protected storage area 11. When user terminal 10 is initially activated, application execution file 91 is installed to protected application storage area 13. When an application is initially activated, certificate data 92 contained in application execution file 91 is decompressed as a certificate file and stored in protected data storage area 14. When an update version installation package tile is distributed, update application execution file 91A from which certificate data have been removed is distributed. When application execution file 91A is executed, the certificate file stored in protected data storage area 14 is used. Thus, an update version application can be distributed and updated in a state in which the administrator of the application distribution server cannot access the client certificate that the application uses.

According to the present invention, the processes that user terminal 10 internally performs are accomplished not only by the foregoing dedicated hardware, but also programs that accomplish such functions in such a manner that the programs are recorded on a record medium from which user terminal 10 can read them and then user terminal 10 reads the programs from the record medium and executes them. The record medium from which user terminal 10 can read programs includes not only movable record mediums such as an IC card, a memory card, a floppy disk (registered trademark), a magneto-optical disc, a DVD, and CD, but also an HDD that is built in user terminal 10. The programs recorded on the record medium are read under the control of the control block. The foregoing processes are performed under the control of the control block.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The present invention can be applied to a portable information terminal (PDA: Portable Data Assistant), a portable telephone terminal (smartphone), and so forth that are provided with an OS that can manage access rights of individual users.

The present application claims priority based on Japanese Patent Application JP 2010-179404 filed on Aug. 10, 2010, the entire contents of which are incorporated herein by reference in its entirety.

1. An application distribution system, comprising:
a terminal that executes an installed execution file of an application and then uses the application; and
an application distribution server that distributes an update execution tile of said application to said terminal,
wherein the execution file installed in the terminal is updated to said update execution file distributed from said application distribution server to said terminal,
wherein the execution tile installed in said terminal contains certificate data that are necessary to use said application, and
wherein said terminal stores the certificate data contained in said execution file as a certificate file in a first storage area that has been access-restricted and when an execution file that does not contain said certificate data is distributed as said update execution file from said application distribution server, said terminal executes the update execution file based on the certificate file stored in said first storage area so as to use the application.

2. The application distribution system according to claim 1,
wherein said terminal includes:
a second storage area in which the execution file that is provided is stored;
first processing means that transfers the execution file stored in said second storage area to a third storage area when the execution file that is stored in said second storage area is installed; and
second processing means that transfers the certificate data, contained in the execution file stored in said third storage area as said certificate file, to said first storage area when the application is initially activated after said execution file is installed and then uses the application based on the certificate file stored in said first storage area,
wherein said first processing means replaces the execution file stored in said third storage area with the update execution file when said update execution program is distributed from said application distribution server, and
wherein said second processing means executes said update execution file stored in said third storage area based on the certificate tile stored in said first storage area so as to use the application.

3. The application distribution system according to claim 2,
wherein the application of said execution file is capable of accessing said first storage area so as to store and read said certificate file in and from said first storage area, and
wherein only a pre-designated user is capable of accessing said second and third storage areas so as to store and read said execution file in and from said second and third storage areas.

4. An application distribution method for a application distribution system, including a terminal that executes an installed execution file of an application and then uses the application; and an application distribution server that distributes an update execution file of said application to said terminal, the execution file installed in the terminal being updated to said update execution file distributed from said application distribution server to said terminal, the execution file installed to said terminal containing certificate data that are necessary to use said application, said application distribution method comprising the processes of:
causing said terminal to store the certificate data contained in said execution file as a certificate file in a first storage area that has been access-restricted;
causing said application distribution server to distribute an execution file, that does not contain said certificate data as said update execution file, to said terminal; and
causing said terminal to execute the update execution file distributed from said application distribution server based on the certificate file stored in said first storage area so as to use the application.

5. The application distribution method according to claim 4, further comprising the processes of:
causing said terminal to store an execution file that is provided in a second storage area;
causing said terminal to transfer the execution file stored in said second storage area to a third storage area when the execution file stored in said second storage area is installed;
causing said terminal to transfer certificate data, contained in the execution tile stored in said third storage area as said certificate tile, to said first storage area when the application is initially activated after said execution file is installed;
causing said terminal to replace the execution tile stored in said third storage area with the update execution file when the update execution file is distributed from said application distribution server; and
causing said terminal to execute said update execution file stored in said third storage area based on the certificate file stored in said first storage area so as to use the application.

6. A terminal that executes an installed execution file of an application and then uses the application and that updates the installed execution file to an update execution file distributed from said application distribution server,
wherein the execution file installed in said terminal contains certificate data that are necessary to use said application, and
wherein certificate data contained in said execution file are stored as a certificate file in a first storage area that has been access-restricted and when an execution file that does not contain said certificate data is distributed as said update execution file from said application distribution server, the update execution file is executed based on the certificate file stored in said first storage area so as to use the application.

7. The terminal according to claim 6, further comprising:
a second storage area in which the execution file that is provided is stored;
first processing means that transfers the execution file stored in said second storage area to a third storage area when the execution file stored in said second storage area is installed; and
second processing means that transfers the certificate data, contained in the execution file stored in said third storage area as said certificate file, to said first storage area when the application is initially activated after said execution file is installed and then uses the application based on the certificate file stored in said first storage area,
wherein said first processing means replaces the execution file stored in said third storage area with the update execution tile when said update execution program is distributed from said application distribution server, and
wherein said second processing means executes said update execution file stored in said third storage area based on the certificate file stored in said first storage area so as to use the application.

8. The terminal according to claim 7,
wherein the application of said execution file is capable of accessing said first storage area so as to store and read said certificate file in and from said first storage area, and
wherein only a pre-designated user is capable of accessing said second and third storage areas so as to store and read said execution file in and from said second and third storage areas.

9. (canceled)

10. (canceled)
